(19) United States
(12) Patent Application Publication
(10) Pub. No.: US 2009/0037352 A1
(43) Pub. Date: Feb. 5, 2009

(54) System and method for automated determination of solutions to known equations

(75) Inventors: Babak Makkinejad, Troy, MI (US); Philip C. Jackson, JR., Troy, MI (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 11/888,507

(22) Filed: Aug. 1, 2007

(51) Int. Cl. G06F 15/18

(52) U.S. Cl. 706/13

(57) ABSTRACT

A system for automated determination of solutions to known equations, including a process orchestrator configured to retrieve at least one known solution from a known solutions datastore, a mathematics preprocessor configured to convert the at least one known solution to at least one machine-usable converted known solution, a genetic algorithm processor configured to generate at least one candidate solution from the at least one machine-usable converted known solution, and a results datastore configured to store a new solution corresponding to the candidate solution. There is also a method including retrieving at least one known solution from a known solutions datastore using a process orchestrator, converting convert the at least one known solution to at least one machine-usable converted known solution, generating at least one candidate solution from the at least one machine-usable converted known solution using a genetic algorithm processor, and storing a new solution corresponding to the candidate solution.

### TECHNICAL FIELD

The present disclosure is directed, in general, to automated tools for mathematic equation derivation and solving.

### BACKGROUND OF THE DISCLOSURE

Einstein field equations (EFE) or Einstein's equations are a set of ten equations in Einstein's theory of general relativity in which the fundamental force of gravitation is described as a curved spacetime caused by matter and energy. They were first published in 1915.

The EFE collectively form a tensor equation and equate the curvature of spacetime (as expressed using the Einstein tensor) with the energy and momentum within the spacetime (as expressed using the stress-energy tensor).

The EFE are used to determine the curvature of spacetime resulting from the presence of mass and energy. That is, they determine the metric tensor of spacetime for a given arrangement of stress-energy in the spacetime. Because of the relationship between the metric tensor and the Einstein tensor, the EFE become a set of coupled, non-linear differential equations when used in this way.

Mathematical form of Einstein's field equation: The Einstein field equations (EFE) may be written in the form:

$${R}_{μν} - \frac{1}{2} {Rg}_{μ ν} = κ {T}_{μν} = \frac{8 π G}{{c}^{4}} {T}_{μν} .$$

where R_{μv} is the Ricci tensor, R the scalar curvature, g_{μv} the metric tensor and T_{μv} the stress-energy tensor. The constant κ (kappa) is called the Einstein constant (of gravitation), where π (pi) is Archimedes' constant, G the gravitational constant and c the speed of light.

The above form of the EFE is for the −+++ metric sign convention, which is commonly used in general relativity. Using the +−−− metric sign convention leads to an alternate form of the EFE which is

$${R}_{μν} - \frac{1}{2} {Rg}_{μ ν} = - κ {T}_{μν} = - \frac{8 π G}{{c}^{4}} {T}_{μν} .$$

The change of sign on the right hand side occurs because the values of T_{μv} have signs which are determined by the sign convention. The value of the left hand side are convention independent: R_{μv} has values which are independent of the convention and the convention dependencies of R and g_{μv} cancel out.

The EFE is a tensor equation relating a set of symmetric 4×4 tensors. It is written here using the abstract index notation. Each tensor has 10 independent components. Given the freedom of choice of the four spacetime coordinates, the independent equations reduce to 6 in number.

Although the Einstein field equations were initially formulated in the context of a four-dimensional theory, the equations can be seen to hold in n dimensions. The equations in contexts outside of general relativity are still referred to as the Einstein field equations (if the dimension is clear).

Despite the simple appearance of the equation it is, in fact, quite complicated. Given a specified distribution of matter and energy in the form of a stress-energy tensor, the EFE are understood to be equations for the metric tensor g_{μv}, as both the Ricci tensor and Ricci scalar depend on the metric in a complicated nonlinear manner. In fact, when fully written out, the EFE are a system of 10 coupled, nonlinear, hyperbolic-elliptic partial differential equations.

One can write the EFE in a more compact form by defining the Einstein tensor

$${G}_{μν} = {R}_{μν} - \frac{1}{2} {Rg}_{μν} ,$$

which is a symmetric second-rank tensor that is a function of the metric. The EFE can then be written as

$${G}_{μν} = \frac{8 π G}{{c}^{4}} {T}_{μν}$$

Using geometrized units where G=c=1, this can be re-written as

G_{μv}=8πT_{μv}.

The expression on the left represents the curvature of spacetime as determined by the metric and the expression on the right represents the matter/energy content of spacetime. The EFE can then be interpreted as a set of equations dictating how the curvature of spacetime is related to the matter/energy content of space.

These equations, together with the geodesic equation, form the core of the mathematical formulation of general relativity.

Equivalent formulations: Einstein's field equations can be rewritten in the following equivalent “trace-reversed” form

$${R}_{μν} = κ ( {T}_{μν} - \frac{1}{2} {Tg}_{μν} )$$

which may be more convenient in some cases (for example, when one's interested in weak-field limit and can replace g_{μv} in the expression on the right with the Minkowski tensor without significant loss of accuracy).

Properties of Einstein's equation and the conservation of energy and momentum: An important consequence of the EFE is the local conservation of energy and momentum; this result arises by using the differential Bianchi identity to obtain

∇ᵥG^{μv}=G^{μv}; v=0

which, by using the EFE, results in

∇ᵥT^{μv}=T^{μv}; v=0

which expresses the local conservation of stress-energy. This conservation law is a physical requirement. In designing the field equations, Einstein aimed at finding equations which automatically satisfied this conservation condition.

Properties of Einstein's equation and nonlinearity: The nonlinearity of the EFE distinguishes general relativity from many other fundamental physical theories. For example, Maxwell's equations of electromagnetism are linear in the electric and magnetic fields, and charge and current distributions (i.e. the sum of two solutions is also a solution); another example is Schrödinger's equation of quantum mechanics which is linear in the wave function.

The correspondence principle: The EFE reduce to Newton's law of gravity by using both the weak-field approximation and the slow-motion approximation. In fact, the constant appearing in the EFE is determined by making these two approximations.

Solutions of the Einstein field equations: The solutions of the Einstein field equations are metrics of spacetime. The solutions are hence often called ‘metrics’. These metrics describe the structure of the spacetime including the inertial motion of objects in the spacetime. As the field equations are non-linear, they cannot always be completely solved (i.e. without making approximations). For example, there is no known complete solution for a spacetime with two massive bodies in it (which is a theoretical model of a binary star system, for example). However, approximations are usually made in these cases. These are commonly referred to as post-Newtonian approximations. Even so, there are numerous cases where the field equations have been solved completely, and those are called exact solutions.

The study of exact solutions of Einstein's field equations is one of the activities of cosmology. It leads to the prediction of black holes and to different models of evolution of the universe.

The description above, and other background information, can be found as of the filing date of this application at en.wikipedia.org/wiki/Einstein_field_equations, all of which is hereby incorporated by reference.

### SUMMARY OF THE DISCLOSURE

Disclosed embodiments include a system for automated determination of solutions to known equations, including a process orchestrator configured to retrieve at least one known solution from a known solutions datastore, and a mathematics preprocessor configured to convert the at least one known solution to at least one machine-usable converted known solution. The system also includes a genetic algorithm processor configured to generate at least one candidate solution from the at least one machine-usable converted known solution, and a results datastore configured to store a new solution corresponding to the candidate solution.

Disclosed embodiments also include a method for automated determination of solutions to known equations retrieving at least one known solution from a known solutions datastore using a process orchestrator, and converting convert the at least one known solution to at least one machine-usable converted known solution. The method also includes generating at least one candidate solution from the at least one machine-usable converted known solution using a genetic algorithm processor, and storing a new solution corresponding to the candidate solution.

Disclosed embodiments also include a computer program product of machine usable instructions encoded in a machine usable medium. The computer program product includes instructions for implementing a process orchestrator configured to retrieve at least one known solution from a known solutions datastore, and instructions for a mathematics preprocessor configured to convert the at least one known solution to at least one machine-usable converted known solution. The computer program product also includes instructions for implementing a genetic algorithm processor configured to generate at least one candidate solution from the at least one machine-usable converted known solution, instructions for implementing a results datastore configured to store a new solution corresponding to the candidate solution.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a block diagram of a system for automated determination of solutions to known equations; and

FIG. 3 illustrates a process in accordance with a disclosed environment.

### DETAILED DESCRIPTION

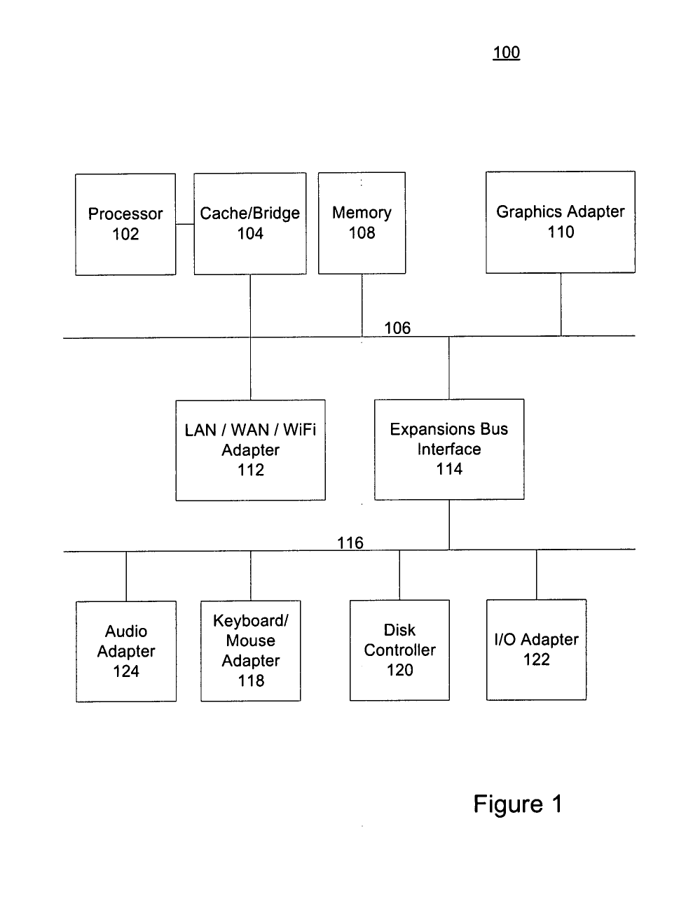

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

There are many known exact solutions to EFEs, and these can be maintained in a database of solutions of Einstein equations. One online resource provides a front-end to a database of the known exact solutions of the Einstein's Field Equations of General Relativity (hereinafter EFE). This online database and front end is located at Internet address 130.15.26.66/servlet/GRDB2.GRDBServlet and is supported by Queen's University. The database is called the “Interactive Geometric Database” (IGD).

The IGD enables a user search for the solution by name. For example, one can type Kerr and the system will list various Kerr or Kerr-Newman solutions. One can then click on any of the solutions to see the line element, the coordinates, etc.

The IGD further allows a user to load the selected solution into a “calculator” which permits one to compute the metric, the Riemann Curvature tensor, etc. The system then displays those mathematical quantities in the mathematical notation.

The IGD provides algebraic calculations of the various mathematical quantities involved in the General Theory of Relativity. The IGD permits export of the mathematical formulas in the TeX typesetting system. The TeX export can then be imported into other tools, such as the mathematics software sold by MapleSoft™. IDG does not support export to more sophisticated mathematics software, such as Wolfram Mathematica®, for further analysis.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Those of ordinary skill in the art will appreciate that the system and method described is not dependent on specific software implementation of any component. For example, the various embodiments are dependent on the use of TeX, nor on the use of Mathematica. For example, the system and method described could be implemented using HTML or XML representation of equations and candidate solutions.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash., or the Solaris operating system, a product of Sun Microsystems located in Santa Clara, Calif., may be employed. Alternatively one of various non-commercial operating systems, e.g. a version of Linux may be employed. The operating system may or may not need to be modified or created in accordance with the present disclosure as described.

Consider the following three solutions of Einstein equations. The exterior Schwarzschild solution for a non-rotating, neutral body of mass M is:

$${ds}^{2} = {c}^{2} ( 1 - \frac{2 GM}{{c}^{2} r} ) {dt}^{2} - {( 1 - \frac{2 GM}{{c}^{2} r} )}^{- 1} {dr}^{2} - {r}^{2} d {Ω}^{2}$$

The Kerr solution for a rotating, neutral body of mass M is:

$${ds}^{2} = - ( 1 - \frac{2 Mr}{Σ} ) {dt}^{2} - \frac{4 α Mr {sin}^{2} θ}{Σ} dtd φ + \frac{Σ}{Δ} {dr}^{2} + Σ d {θ}^{2} + ( {r}^{2} + {a}^{2} + \frac{2 {a}^{2} Mr {sin}^{2} θ}{Σ} ) {sin}^{2} θ d {φ}^{2}$$

$$with$$

$$Σ = {r}^{2} + a 2 cos {θ}^{2} , Δ = {r}^{2} - 2 Mr + {a}^{2} .$$

The Kerr-Newman solution for a rotating, electrically charged body of mass M is:

$${ds}^{2} = - \frac{Δ}{{ρ}^{2}} {( dt - a {sin}^{2} θ d φ )}^{2} + {\frac{{sin}^{2} θ}{{ρ}^{2}} [ ( {r}^{2} + {a}^{2} ) d φ - adt ]}^{2} + \frac{{ρ}^{2}}{Δ} {dr}^{2} + {ρ}^{2} d {θ}^{2}$$

$$with$$

$$Δ {=}^{def} {r}^{2} - 2 Mr + {a}^{2} + {Q}^{2} , \\ {ρ}^{2} {=}^{def} {r}^{2} + {a}^{2} {cos}^{2} θ , \\ a {=}^{def} \frac{J}{M}$$

The Kerr solution is a special case of the Kerr-Newman solution and the Schwarzchild solution is a special case of the Kerr solution. It is then possible to derive the Kerr and Kerr-Newman solutions by altering the Schwarzchild metric. In other words, given the Schwarzchild metric, one can automate the exploration of the space of the solution space of the Einstein's equations and arrive at the Kerr or Kerr-Newman solutions (or an approximation thereto).

The disclosed embodiments include a system and method in which one or more known solutions can be loaded, and a genetic algorithm used to produce additional solutions and to measure the fitness of the solutions. In a particular exemplary implementation, the system can obtain one or more exact solutions from the IGD database, and apply a genetic algorithm program to produce solutions that are “descendants” of the initial exact solution(s), and use mathematical software techniques to measure the fitness of the solution. This can be implemented, for example, using the Microsoft .Net® software framework, and interacting with a known mathematics software such as the software produced by MapleSoft™ or such as Wolfram Mathematica® mathematics software. Those of skill in the art will recognize that the solutions can be and typically are stated as equations themselves, e.g., the Schwarzchild metric is stated as an equation.

The system and method disclosed herein includes embodiments in which automated transformations and substitutions are applied to the known solutions, which transform them to mathematically equivalent but differently structured solutions, prior to the use of the known solutions by the genetic algorithm. Such transformations and substitutions may be either predefined, or selected dynamically by the system. Dynamic selection may include but not necessarily be limited to pseudorandom selection of transformations and substitutions. One advantage of such transformations and substitutions would be to allow the genetic operations to act on higher level or lower level structural components. This can augment and potentially speed up the genetic search.

A custom or commercial mathematics software application is programmed to perform the algebraic manipulations for substituting each candidate solution into the Einstein equations and computing how well that candidate solution satisfies the Einstein's equations. The disclosed system is thereby used to determine new exact and approximate solutions of Einstein equations.

The disclosed system and method can also be used, for example, for the discovery of new exact and approximate solutions of Maxwell's Equations as well.

The disclosed system and method can also be used, for example, for the discovery of new exact and approximate solutions of the Navier-Stokes Equations or of Schrodinger's Equation as well. Those skilled in the art will understand that the disclosed system and method can be used for the discovery of new exact and approximate solutions of any well-defined equation or system of equations, without limitation to a particular theory or domain of physics or other field of study.

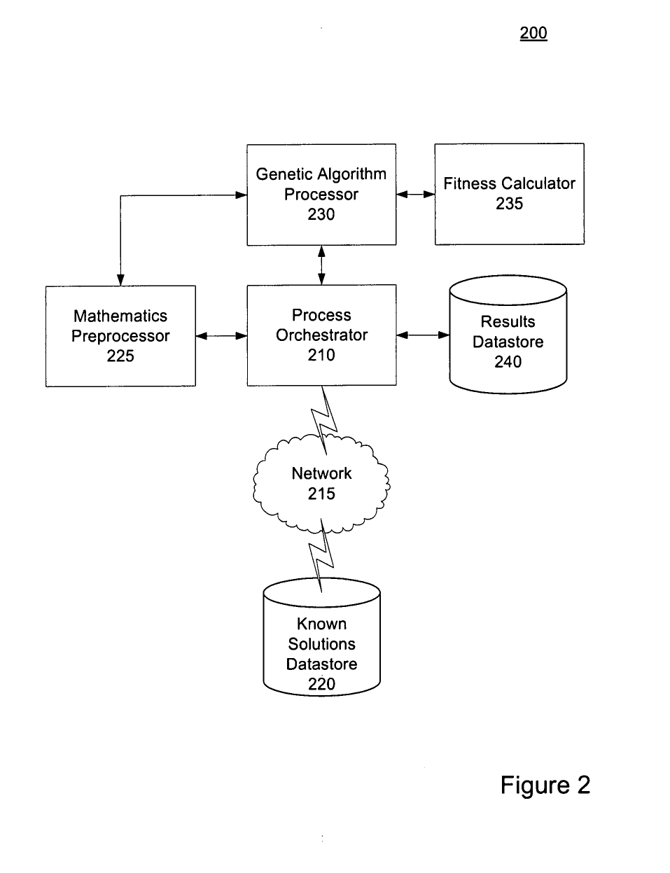

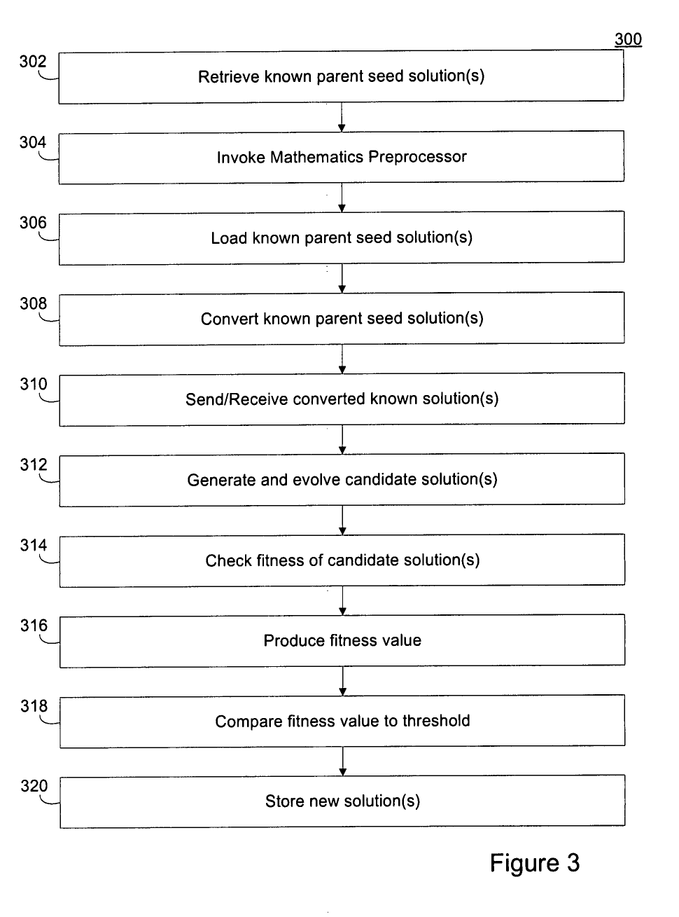

FIG. 2 depicts a block diagram of a system for automated determination of solutions to known equations, including in particular the EFE. FIG. 3 illustrates a process in accordance with a disclosed environment.

The disclosed process is initiated by a software component called Process Orchestrator 210. This software component retrieves one or more parent seed known solutions from a Known Solutions Datastore 220 (step 302). In one embodiment, the known solution(s) can be an EFE or collection of EFEs respectively and the Known Solutions Datastore 220 can be the IGD or other publicly-accessible datastore connected to the Internet. Process Orchestrator 210 can be implemented as a data processing system 100, and can communicate with known solutions datastore 220 over network 215. Network 215 can be any public or private network, or combination of networks, including the Internet.

Note that, although various components are shown herein as directly connected, in distributed computing applications, any components can communicate instead over network 215.

The Process Orchestrator 210 invokes Mathematics Preprocessor 225 (step 304), which can be a preprocessor for Maple™ or Mathematica® mathematics software.

The Mathematics Preprocessor 225 loads the known solution(s) (step 306), as a TeX output for example, from the Known Solutions Datastore 220 through the Process Orchestrator 210. The Mathematics Preprocessor 225 converts the known solution(s) to a form suitable for further processing by Genetic Algorithm Processor 230 (step 308). This form can be a machine-useable representation of the known solution(s), where the known solution(s) may be originally in a format optimized for human review. The Mathematics Preprocessor 225 both stores and sends the converted known solution(s) to the Genetic Algorithm Processor 230 (step 310), which receives the known solution(s). In various implementations, a commercial software package such as the software produced by MapleSoft™ or the Scientific Word™ software produced by MacKichan Software, Inc. can pre-process TeX to a form amenable to computer algebra manipulation.

Genetic Algorithm Processor 230 generates and stores candidate solutions and starts “evolving” them (step 312). Methods for generating candidate solutions include randomly mutating (changing) known solution(s) and/or combining known solution(s). Parts of known solutions may be mutated (changed) and may be combined to form one or more new candidate solutions. For each evolutionary step, Genetic Algorithm Processor 230 queries the Fitness Calculator 235 for the fitness of each individual candidate solution against a set of known equations, such as the EFE. The Fitness Calculator 235 uses the symbolic mathematics computational capabilities of a custom or commercial mathematics software application to calculate how well a given individual candidate solution satisfies the EFE (step 314). Fitness Calculator 235 can be implemented using, for example, Maple™ or Mathematical mathematics software. Fitness Calculator 235 produces and stores a fitness value corresponding to the amount to which the candidate solution fits the EFE (step 316).

Those of skill in the art are familiar with genetic algorithms. One example of a genetic algorithm implementation is found in the MSDN article “Survival of the Fittest: Natural Selection with Windows Forms” by Brian Connolly, which is available as of the filing data of this application at internet address msdn.microsoft.com/msdnmag/issues/04/08/GeneticAlgorithms, and is hereby incorporated by reference.

The fitness value is communicated to the Genetic Algorithm Processor 230, which uses that data to breed new generations of solutions, where each fitness value is compared to a fitness threshold value. This is a back and forth communication process that is continued until the fitness value satisfies meets or exceeds the fitness threshold value specified by the Process Orchestrator 210 (step 318), at which point the candidate solution is determined to be a new solution to the equations.

At that point, the Process Orchestrator 210 stores the new solution into a Results Datastore 240 (step 320) and resumes searching for a new solution based on one or more other exact solutions from the Known Solutions Datastore 220. In some embodiments, the new solutions stored in the Results Datastore 240 can be used as known solutions, and the Results Datastore 240 can be used as Known Solutions Datastore 220.

Note that, in various embodiments, one or more of Process Orchestrator 210, Known Solutions Datastore 220, Mathematics Preprocessor 225, Genetic Algorithm Processor 230, Fitness Calculator 235 and Results Datastore 240 can be implemented in a single data processing system 100, using processor 102, memory 108, and disk controller 120 to function as appropriate processing and storage means, and LAN/WAN/WiFi Adapter 112 for any required network communications. In distributed computing embodiments, one or more of the above components can each be implemented in a separate data processing system 100. In still other embodiments, instead of communicating with Known Solutions Datastore 220 over a network, Known Solutions Datastore 200 is maintained on the same data processing system as Process Orchestrator 210. Each of the components above can be implemented using a special-purpose or general-purpose controller, ASIC, or other technology known to those of skill in the art, combined with appropriate storage means, implemented as any known machine usable medium.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A system for automated determination of solutions to known equations, comprising:
a process orchestrator configured to retrieve at least one known solution from a known solutions datastore;
a mathematics preprocessor configured to convert the at least one known solution to at least one machine-usable converted known solution;
a genetic algorithm processor configured to generate at least one candidate solution from the at least one machine-usable converted known solution; and
a results datastore configured to store a new solution corresponding to the candidate solution.

2. The system of claim 1, further comprising a fitness calculator configured to calculate how well a candidate solution satisfies a set of known equations.

3. The system of claim 2, wherein the fitness calculator produces a fitness value according to how well a candidate solution satisfies a set of known equations.

4. The system of claim 3, wherein the process orchestrator is further configured to compare the fitness value to a fitness threshold value.

5. The system of claim 2, wherein the genetic algorithm processor is further configured to query the fitness calculator for each candidate solution.

6. The system of claim 1, wherein the known solutions datastore is a publicly-accessible datastore connected to the Internet.

7. The system of claim 1, the known solutions datastore is a datastore of known solutions to Einstein's Field Equations.

8. The system of claim 1, wherein the known solution is in the TeX typesetting system form.

9. The system of claim 1, wherein the new solution corresponds to a candidate solution that fits a set of known solutions to within a threshold.

10. The system of claim 1, the known solutions datastore is a datastore of known solutions to Maxwell's Equations

11. The system of claim 1, the known solutions datastore is a datastore of known solutions to Navier-Stokes Equations.

12. A method for automated determination of solutions to known equations, comprising:
retrieving at least one known solution from a known solutions datastore using a process orchestrator;
converting convert the at least one known solution to at least one machine-usable converted known solution;
generating at least one candidate solution from the at least one machine-usable converted known solution using a genetic algorithm processor; and
storing a new solution corresponding to the candidate solution.

13. The method of claim 12, further comprising calculating how well the candidate solution satisfies a set of known equations.

14. The method of claim 13, further comprising producing a fitness value according to how well the candidate solution satisfies a set of known equations.

15. The method of claim 14, further comprising comparing the fitness value to a fitness threshold value.

16. The method of claim 12, further comprising querying a the fitness calculator for each candidate solution.

17. The method of claim 12, wherein the known solutions datastore is a publicly-accessible datastore connected to the Internet.

18. The method of claim 12, wherein the new solution corresponds to a candidate solution that fits a set of known solutions to within a threshold.

19. A computer program product of machine usable instructions encoded in a machine usable medium, comprising:
instructions for implementing a process orchestrator configured to retrieve at least one known solution from a known solutions datastore;
instructions for a mathematics preprocessor configured to convert the at least one known solution to at least one machine-usable converted known solution;
instructions for implementing a genetic algorithm processor configured to generate at least one candidate solution from the at least one machine-usable converted known solution; and
instructions for implementing a results datastore configured to store a new solution corresponding to the candidate solution.

20. The computer program product of claim 19, wherein the new solution corresponds to a candidate solution that fits a set of known equations to within a threshold.
